(19) United States
(12) Patent Application Publication
(10) Pub. No.: US 2014/0309072 A1
(43) Pub. Date: Oct. 16, 2014

(54) DIFFERENTIAL GEAR

(71) Applicant: Schaeffler Technologies GmbH & Co. KG, Herzogenaurach (DE)

(72) Inventors: Ralph Schimpf, Fuerth (DE); Thorsten Biermann, Wachenroth (DE)

(73) Assignee: Schaeffler Technologies GmbH & Co. KG, Herzogenaurach (DE)

(21) Appl. No.: 14/218,277

(22) Filed: Mar. 18, 2014

(30) Foreign Application Priority Data
Apr. 16, 2013 (DE) 102013206741.0

(51) Int. Cl. F16H 48/38

(52) U.S. Cl. CPC F16H 48/38
USPC 475/220

(57) ABSTRACT

A differential gear having a gear housing, an epicyclic gear housing, which is arranged in the gear housing in a manner allowing rotation about a gear axis, a drive wheel which sits on the epicyclic gear housing for the purpose of driving the epicyclic gear housing, a first bearing device for the purpose of mounting a first axial end region of the epicyclic gear housing radially, and a second bearing device for the purpose of mounting a second axial end region of the epicyclic gear housing radially, wherein the second bearing device has a first and a second roller element crown which bear axially in opposite directions, and the axial position of the epicyclic gear housing with respect to the gear housing is determined by the second bearing device.

### CROSS-REFERENCE TO RELATED APPLICATIONS

This patent claims priority from German Patent Application No. 10 2013 206 741.0, filed Apr. 16, 2013, which application is incorporated herein by reference its entirety.

### FIELD OF THE INVENTION

The invention relates to a differential gear having a gear housing, an epicyclic gear housing which is arranged in the gear housing in a manner allowing rotation about a gear axis, and a planetary carrier which sits in the epicyclic gear housing, wherein the drive power applied to the epicyclic gear housing is split by means of this differential gear, and the planetary carrier and the epicyclic gear housing can be selectively coupled to each other by a friction fit via a coupling device.

### BACKGROUND OF THE INVENTION

Differential gears are generally constructed as planetary wheels, and most commonly serve the purpose of splitting or distributing an input power, supplied by a power input, to two drive shafts. Differential gears are most frequently used in the building of automobiles as so-called axle differentials. In this case, drive power supplied by a drive motor is distributed via the differential gear to wheel drive shafts of driven wheels. The two wheel drive shafts leading to the wheels in this case are each driven at the same torque, meaning they are balanced. When the vehicle drives straight forward, both wheels rotate at the same speed. When the vehicle travels a curve, the rotation speeds of each wheel are different. The axle differential makes this rotation speed difference possible. The rotation speeds are able to adjust themselves freely; only the average of the two speeds is unchanged.

In certain applications, particularly in all-wheel drive vehicles, differential gears are used which enable a switchable decoupling when the all-wheel drive function is not necessary, and additionally enable a separation in the drivetrain in order to drive the vehicle via only one axle, thereby reducing friction loss in the drive system, the same being not necessary at the moment, but otherwise driven anyway. Such a differential gear is known from DE 10 2008 037 885, by way of example.

A differential gear is likewise known from U.S. Pat. No. 4,679,463, which enables a switchable coupling of the planetary carrier to an epicyclic gear housing which houses said planetary carrier and which is driven by a ring gear. The epicyclic gear housing is mounted in a differential gear housing, both radially and axially, via a first and a second bevel gear.

The problem addressed by the invention is that of creating a differential gear of the type named above, which enables a switchable release of the drive connection between the power input and the two power outputs, and which is characterized by a robust mounting of the epicyclic gear housing, said mounting having advantageous tribological conditions.

### BRIEF SUMMARY OF THE INVENTION

The problem named above is addressed according to the invention by a differential gear, having a gear housing, an epicyclic gear housing which is arranged in the gear housing in a manner allowing rotation about a gear axis, drive wheel which sits on the epicyclic gear housing for the purpose of driving the epicyclic gear housing, a first bearing device for the purpose of mounting a first axial end region of the epicyclic gear housing radially, and a second bearing device for the purpose of mounting a second axial end region of the epicyclic gear housing radially, wherein the second bearing device has a first and a second rolling element crown which are arranged in such a manner that they bear axially in opposite directions, and the axial position of the epicyclic gear housing with respect to the gear housing is determined by the second bearing device.

In this way, it is advantageously possible to create a differential gear wherein it is possible for the axial force components engaging with the epicyclic gear housing to be transferred into the gear housing, via the second bearing device, in a manner which is advantageous for the structural mechanics of the differential gear, and wherein the axial position of the epicyclic gear housing in the gear housing can be determined precisely via the second bearing device.

The differential gear according to the invention is preferably constructed in such a manner that the differential gear has a planetary carrier arranged in the epicyclic gear housing coaxially with the gear axle, as well as a brake device, for the purpose of generating a coupling torque which couples the planetary carrier to the epicyclic gear housing. The brake device in this case is preferably formed by a brake disk pack which is composed of multiple annular brake disks. The axial load on the brake disks needed to bring about a coupled state can be generated in a controlled manner via an actuating mechanism.

The second bearing device is preferably constructed in such a manner that it has a ring element which forms a first and a second end face which bear axially, as well as a flange section having a cylindrical running surface. This ring element is preferably axially connected to the epicyclic gear housing in a manner guaranteeing tensile strength, via the region of the flange section.

The cylindrical running surface of the ring element is supported in an advantageous manner by a needle roller bearing crown. The end faces of the ring element which bear axially are supported axially in an advantageous manner by a first and/or a second cylindrical roller bearing crown, the roller elements of which roll directly on the corresponding, axially-bearing end face of the ring element.

The ring element itself is preferably made as a molded sheet metal part, and designed in such a manner that it has an angular cross-section in an axial section thereof. As an alternative to this manner of manufacture, it is also possible for the ring element to be made as a forged component, or to be made by the machining of a solid material, particularly a section of a tubular disk.

The ring element can be designed in such a manner that the flange section thereof which forms the cylindrical running surface can be seated on a cylindrical flange of the epicyclic gear housing with a tight fit, and can be fixed in this position. In this case, a circular shoulder can be constructed on the inner side of the ring element, which as such determines the axial position of the ring element slid against the cylindrical flange of the epicyclic gear housing. The axial fixation of the ring element can be realized by a stamped press fit, by local plastic deformation of the epicyclic gear housing, by a threaded connection, by attachment and/or securing means, or particularly by the creation of local welded connection points.

The first bearing device is preferably designed as a cylindrical roller bearing, and has an inner bearing ring and an outer bearing ring. The inner bearing ring in this case preferably sits directly on a further cylindrical flange section of the epicyclic gear housing, and is fixed there axially in the direction of the pushing movement as well.

The axial position of the epicyclic gear housing in the gear housing is set, in an advantageous manner, via the second bearing device. In order to achieve a certain pretension for the second bearing device, it is possible, in an advantageous manner, to place a load on the two cylindrical roller bearing crowns of the second bearing device, said cylindrical roller bearing crowns bearing axially, via a cover element, the geometry and structural strength of which are determined in such a manner that an axial pretension on the second bearing device results in the process of the cover element being fixed on the gear housing, said pretension being at least sufficient for removing any axial play.

The epicyclic gear housing is preferably designed as a two-part structure, and composed in this case of a first and a second bowl element. The inner ring of the first bearing device and the ring element are each seated on the cylindrical ring flange, of the respective bowl element functionally assigned thereto, with a close fit.

The first bearing device, which functions as such as a floating bearing, can be designed in an advantageous manner in such a manner that it has an axially-fixed outer bearing ring on the gear housing, wherein the axial force which engages the brake device is diverted via a roller bearing, the same being designed particularly as a cylindrical roller bearing providing axial support, wherein the roller elements thereof roll directly on the end face of the first outer bearing ring. The roller elements of this roller bearing are preferably themselves guided in a cage device. The cage device in this case can be designed in such a manner that it forms a retainer which as such properly holds the roller elements together during the assembly of the gear or in the event of another manner of the epicyclic gear housing moving away from the outer bearing ring axially.

In a particularly preferred embodiment of the invention, the differential gear according to the invention is designed as a spur gear differential gear and has a first output sun gear, a second output sun gear, and a planet arrangement accommodated in the planetary carrier, for the purpose of coupling the two output sun gears to each other in a manner allowing rotation in opposite directions.

The planet arrangement is preferably designed in turn in such a manner that it has multiple revolving planets which, as such, are able to rotate about planetary axes which are oriented parallel to the gear axle. The brake device is designed in such a manner that the brake disk pack is positioned at the radial distance of the planetary axes.

A ring gear is seated on the epicyclic gear housing. The power input into the epicyclic gear housing is realized via this ring gear. A right-angled drive can be implemented with an interface to this ring gear. This construction is particularly suitable for use as a rear differential which can be reversibly disengaged. It is also possible to arrange a spur gear on the epicyclic gear housing in the place of the ring gear, for the purpose of inputting the drive power.

The inner differential included in this case, the same accommodated in the interior of the epicyclic gear housing, is designed as a spur gear differential having two output sun gears which are able to rotate in opposite directions, via a planetary arrangement. This spur gear differential is, according to a particularly preferred embodiment of the invention, designed with a Wildhaber/Novikov toothing. Details on the geometries which are preferably implemented on the respective toothed wheels in this case, as well as the addendum and foot circle diameters of the output sun gears and the revolving planet gears which engage with the same, are explained in the description of the figures.

In the differential gear according to the invention, the differential cage is connected in a switchable manner to the drive wheel via a multi-disk clutch. According to the invention, the epicyclic gear housing which receives the multi-disk clutch is mounted via a double thrust bearing. The epicyclic gear housing is simultaneously the clutch housing. The double thrust bearing is formed by two axial needle roller bearing crowns and at least one axial bearing washer between the axial needle roller bearing crowns, said bearing washer bearing axially. In the differential gear according to the invention, the division of the power is preferably realized via Wildhaber-Novikov spur gear toothing. In sum, the differential gear according to the invention is a planetary differential with a hypoid gear and an integrated clutch. The clutch is seated in an epicyclic gear housing which carries the hypoid gear, said epicyclic gear housing being positioned axially in the gear housing via a double thrust bearing which functions as a fixed bearing.

### BRIEF DESCRIPTION OF THE DRAWINGS

Further details and features of the invention are found in the following description, with reference to the drawing, wherein:

FIG. 1 shows an axial cutaway view which clarifies the construction of a differential gear according to the invention, wherein the coupling of the planetary carrier to a bowl housing which receives the same is realized via a brake disk pack, which extends along the radial distance or track of the planet gear bearing pin axes with respect to the gear axle, and wherein one of the two bearing devices which bear the epicyclic gear housing is designed as a fixed bearing having two cylindrical roller bearing crowns which bear axially in two opposite directions for the purpose of positioning the epicyclic gear housing axially.

### DETAILED DESCRIPTION OF THE INVENTION

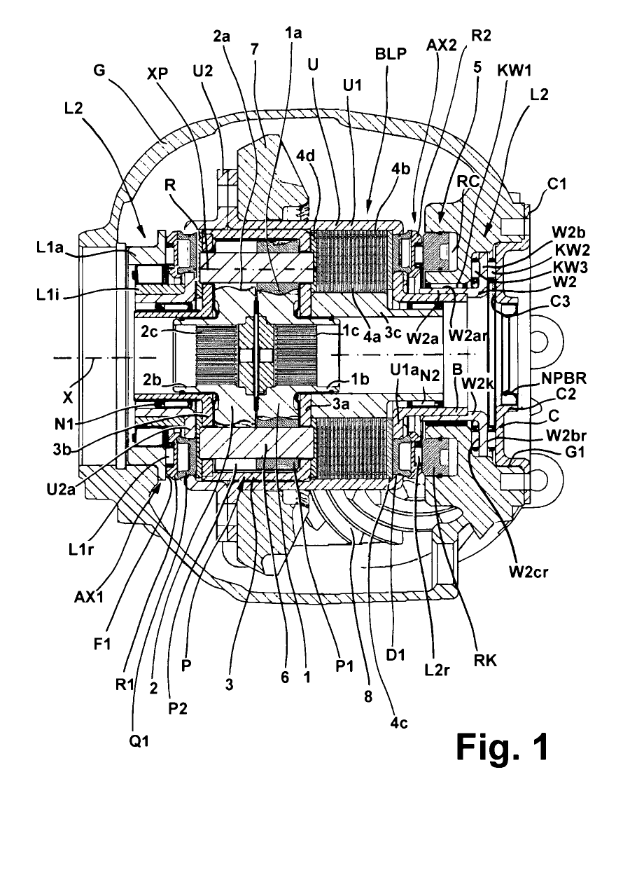

The illustration according to FIG. 1 shows a differential gear according to the invention. The same has a gear housing G and an epicyclic gear housing U which is mounted in the gear housing G in a manner allowing rotation about a gear axis X. A planetary carrier 3 is received in the epicyclic gear housing U, which in turn is arranged coaxially to the gear axle X.

The differential gear further comprises a first output sun gear 1, a second output sun gear 2, and a planetary arrangement P accommodated in the planetary carrier 3, for the purpose of coupling the two output sun gears 1, 2 in a manner allowing rotation in opposite directions.

A brake device is positioned in the differential gear, which in this case is designed as a brake disk pack BLP, for the purpose of generating a coupling torque which selectively couples the planetary carrier 3 to the epicyclic gear housing U, according to the magnitude of an axial force engaging the brake disk pack BLP.

In addition, the differential gear according to the invention has an actuating mechanism 5 for the purpose of generating the axial force applied to the brake disk pack BLP. The brake disk pack BLP is integrated into the differential gear in such a manner that it couples the planetary carrier 3 to the epicyclic gear housing U with a friction fit when there is a corresponding axial load. As a result of this approach, it is possible to release the drive connection between the planetary carrier 3 and the epicyclic gear housing U by unloading the brake disk pack BLP and/or to couple the planetary carrier 3 to the epicyclic gear housing U with a friction fit by means of loading the brake disk pack BLP axially. The actuating mechanism 5 is accommodated in the gear housing G in a stationary manner, and is kinematically coupled to the components which revolve together with the epicyclic gear housing via a mechanism which is described in greater detail below.

The differential gear which in this case includes the planetary carrier 3, the planetary arrangement P and the output sun gears 1, 2 is designed as a spur gear differential with two output sun gears 1, 2. The planetary arrangement P has multiple revolving planets P1, P2 which are mounted as such on planet pins 6.

The mounting of the epicyclic gear housing U in the gear housing G is realized via a first bearing device L1 and a second bearing device L2. The first bearing device L1 has a roller bearing L1 which bears axially and which in this case is designed as a cylindrical roller bearing crown, by way of example, said roller bearing having an inner bearing ring L1i and an outer bearing ring L1a which is fixed to the gear housing G.

The first bearing device L1 serves the purpose of radially mounting a first axial end region of the epicyclic gear housing U. The first bearing device L1 functions as a floating bearing in this case.

The second bearing device L2 serves the purpose of radially mounting a second axial end region of the epicyclic gear housing U, and of axially supporting the epicyclic gear housing U. The second bearing device L2 has a ring element W2 which has a cylindrical flange section W2a and a ring shoulder W2b which bears axially. The cylindrical flange section W2a forms a cylindrical running surface W2ar. The ring shoulder W2b forms a first end face W2br which functions as a roller element running surface, and a second end face W2cr which likewise functions as a roller element running surface. The cylindrical running surface W2ar and the end faces W2br, W2cr, the same bearing axially, are supported radially and/or axially by separate roller element crowns KW1, KW2, KW2.

The roller element crown KW1 which radially supports the cylindrical running surface W2ar of the ring element W2 is designed as a needle roller bearing crown. The two roller element crowns KW2, KW3 which support the ring shoulder W2b axially in opposite directions are designed as cylindrical roller bearing crowns. The ring element W2 itself is designed as a molded sheet metal part in this case, and has an angular cross-section in the axial section thereof which is present in this case. The ring element W2 is seated on a cylindrical flange B2 of the epicyclic gear housing U and axially fixed in place. The axial position of the ring element W2 as slid onto the cylindrical flange B2 is determined by a small annular step W2k which projects radially inward.

The first bearing device L1 is designed in this case as a cylindrical roller bearing crown, as already addressed above, and functions as a floating bearing which only bears radially. The axial position of the epicyclic gear housing U in the gear housing G is determined via the roller element crowns KW2, KW3 of the second bearing device L2. In this case, the cylindrical roller bearing crown KW2 of the second bearing device L2, said cylindrical roller bearing crown bearing axially, is supported on a cover element C, the geometry and structural strength of which is such that an adequate axial pretension on the second bearing device L2, meaning the fixed bearing, results from the process of the cover element being fixed in the second bearing device L2.

As a result of the concept according to the invention, a fixed bearing is realized via the second bearing device L2, which as such also directs the axial forces engaging the ring gear 7 into the gear housing G. The radial mounting of the epicyclic gear housing U is realized by the first roller element crown KW1, which is designed as a needle roller bearing. An axial rigidity of the fixed bearing L2, said rigidity being specifically adjustable, is achieved via the axial pretensioning of the two needle roller bearing crowns KW2, KW3 which support the ring element W2 axially. The cover element C has a defined axial rigidity and functions as a “disk spring,” which as such pretensions the fixed bearing L2 in a defined manner.

The ring element W2 which is pulled over on the side opposite the floating bearing L1, for the purpose of mounting the epicyclic gear housing U according to the invention, penetrates the region of the actuating mechanism 5, with its cylindrical flange section W2a. The ring shoulder W2b which bears axially on both sides, extends to a side of the actuating mechanism 5 which is opposite the epicyclic gear housing U. The cover element C is made as a molded sheet metal part and placed axially on the gear housing G via a circular flange section C1, then fixed in this position via screws which are not shown in greater detail here. The cover element C is centered in a corresponding recess bore hole G1 of the gear housing. The cover element C has an inner circular flange C2 in which a sealing ring NPBR sits. The cover element C forms an inner end face C3 which functions as a running surface, on which the roller elements of the second roller element crown KW2 roll. As a result of the concept shown here, it is possible for the second bearing device L2, the same configured for the purpose of positioning the epicyclic gear housing U, to gently pretension itself axially, wherein both roller element crown KW2, KW3, the same bearing axially, are positioned on a side of the actuating mechanism 5 which is opposite the epicyclic gear housing U, and the roller element crown KW1 used for the radial mounting is arranged inside an opening which is surrounded by the actuating mechanism 5. This roller element crown KW1 can roll directly on a cylindrical inner wall of the gear housing, or preferably in a needle roller bearing socket which is not illustrated here, and which is inserted with a slight press-fit seat in the region of the bore hole which can be recognized here.

The axial force F which engages the brake device BLP in the embodiment is directed via a thrust bearing AX1 which is supported on a radial end face F1 of the first outer bearing ring L1a or the first roller bearing L1.

This first thrust bearing AX1 in this case is designed as a cylindrical roller bearing. The cylindrical rolls L1r of the cylindrical roller bearing roll directly on the end face F1 of the first outer bearing ring L1a. The first thrust bearing AX1 has a first thrust bearing race R1 on which the roller elements L1r of the first thrust bearing AX1 are likewise axially supported.

A second thrust bearing AX2 is included on a side of the epicyclic gear housing U which is opposite the first thrust bearing AX1. This second thrust bearing AX2 has a second thrust bearing race R2. The roller elements L2r of the second thrust bearing AX2 are supported axially on the annular piston RK.

The planetary arrangement P comprises multiple revolving planets P1, P2 which as such are able to rotate about planetary axes XP which are oriented parallel to the gear axle X. The brake device is designed in such a manner that the brake disk pack BLP is positioned at the radial distance of the planetary axes XP. The raceway of the first thrust bearing race R1 is likewise positioned at the radial distance of the brake disk pack BLP.

The epicyclic gear housing U is designed as a bowl housing, and the transmission of axial force between the planetary carrier 3 and the first thrust bearing race R1 is realized via plunger elements Q1 which are guided through a base surface of the bowl housing with axial float.

In the differential gear according to the invention, the brake disk packs BLP and the planetary carrier 3 are designed to match each other in such a manner that the brake disk pack BLP is positioned at the radial distance or track distance of the planetary axes XP which are parallel to the gear axle X. As a result of this special construction, it is possible for the axial force which engages the brake disk pack BLP to be directed through the planetary carrier 3 axially to the race R1, “extended in a straight line,” while incorporating the planet pins 6 which are oriented parallel to the gear axle X.

The brake disk pack BLP has a set of first, annular brake disks 4a which engage with the planetary carrier 3 via an inner edge contour thereof, in a non-rotatable manner, but nevertheless allowing axial sliding. The brake disk pack BLP has a set of second brake disks 4b which engage with the epicyclic gear housing U via an outer edge contour, in a non-rotatable manner, but nevertheless allowing axial sliding. These brake disks 4a, 4b are designed as flat steel sheet metal hollow disks, and preferably are coated with a friction material layer.

The axial support of the brake disk pack BLP on the planet pins 6 is realized with the integration of a pressure ring element 4d which is supported on the end faces of the planet pins 6. The planetary carrier 3 and the brake disk pack BLP are matched to each other in such a manner that the radial distance of each of the planet pin axes XP from the gear axle X is greater than the inner diameter of a brake disk 4a, 4b, and also is small than the outer diameter of the brake disk 4a, 4b.

The epicyclic gear housing U included for the purpose of receiving the planetary carrier 3 is designed as a two-part bowl housing, and composed of a first bowl element U1 and a second bowl element U2, wherein the first bowl element U1 has a base section U1a which extends inward radially. This base section U1a of the first bowl element U1 in this case is configured with circular passages D1 which pass through said base section U1a in sequential positions at equal distances around the periphery. The plunger elements Q2 of a set of plunger elements sit in these passages D1. These plunger elements Q2 are guided in the passages D1 in a manner allowing axial sliding in the direction of the planet axes XP. These plunger elements Q2 function as pressure transmission organs between the inner region of the bowl housing U and the outer region of the same. A roller guide ring R2 is seated on a side of the plunger elements Q2, on these plunger elements Q2, said side being opposite the brake disk pack BLP, wherein said roller guide ring R2 can be loaded axially via the annular piston RK, with the rollers L2r connected in-between, for the purpose of axially pressing the brake disk pack BLP together.

The annular piston element RK is received in a circular chamber RC which is concentric with the gear axle X, and can be moved axially according to the magnitude of a fluid pressure applied to the circular chamber RC via a fluid channel which is not shown here in greater detail. This annular piston element RK impels the rollers L2r of the roller guide ring R2, said rollers running toward the same, toward the planetary carrier 3, meaning in the direction of the brake disk pack BLP. The circular chamber RC above is completely molded into the gear housing G in this case.

The planetary carrier 3 is likewise supported by plunger elements Q1 on the side thereof which is opposite the brake disk pack BLP, said plunger elements in turn being guided through a base surface U2a of the epicyclic gear housing U and supported on the end face thereof by the first roller ring R1. These plunger elements Q1 are designed with the same construction as the plunger elements Q2 named above.

The roller ring R1 carries a roller arrangement L1r which runs directly to an end face of an outer bearing ring L1a of a bearing L1 which supports the epicyclic gear housing U. The roller ring R1 can be designed in such a manner that it is centered by the inner bearing ring L1i of this bearing L1. In the embodiment shown here, the inner bearing ring L1i receives the radial forces which act on the epicyclic gear housing U. The thrust bearing AX1 receives the axial forces of the brake disk pack BLP which are transmitted out of the epicyclic gear housing U via the floating plunger elements Q1. The actuating forces generated by the annular piston element RK are therefore transferred directly into the gear housing G via the outer bearing ring L1a of the floating bearing L1.

The plunger elements Q1, Q2 can be seated sectionally in suitable receiving pockets of the roller rings R1, R2, and optionally secured, to prevent them falling out, in the same by means of a press-fit, by way of example. A locking device can be implemented by means of the plunger elements Q1, Q2 in relation to the roller rings R1, R2, such that the roller rings R1, R2 are able to travel together with the plunger elements Q1, Q2 functionally assigned to the same, but are not able to rotate with respect to the epicyclic gear housing U.

The first and second revolving planets P1, P2 engage directly with each other, and are therefore coupled in a driving relationship to each other, in such a manner that they rotate in opposite directions. In this embodiment, there is a total of four revolving planets P1 which engage with the first output sun gear 1. These revolving planets P1 which engage with the first output sun gear 1 form a first set of revolving planets. In addition, in this embodiment, there is a total of four revolving planets P2 which engage with the second output sun gear 2. These revolving planets P2 which engage with the second output sun gear 2 form a second set of revolving planets. Each revolving planet P1 of the first set engages with one revolving planet P2 of the second set. The engagement of the revolving planets P1 of the first set with the revolving planets P2 of the second set is realized at the same tooth plane as the engagement of the revolving planets P1 of the first set with the output sun gear 1.

As an alternative to the embodiment described here, having four planet pairs, other numbers of planet pairs are also possible, particularly 2, 3, and 5 planet pairs. It is also possible for the planet pairs to be designed and arranged overall such that they form a planet crown which is closed in itself, wherein each planet gear thereof engages with the sun gear assigned to the same, as well as with two neighboring planets which are functionally assigned to the other sun gear.

The first output sun gear 1 and the second output sun gear 2 are matched to each other, in regards to the tooth geometry thereof, in such a manner that the addendum circle of the spur gear toothing 1a of the first output sun gear 1 is smaller than the root circle of the output sun gear toothing 2a of the second output sun gear 2. The revolving planets P1 of the first set engage with the revolving planets P2 of the second set in the region of the tooth plane of the first output sun gear 1. The two output sun gears 1, 2 are directly adjacent to each other.

The two output sun gears 1, 2 are designed in such a manner that that the output sun gear toothing 1a of the first output sun gear 1, and the output sun gear toothing 2a of the second output sun gear 2 have the same number of teeth. The revolving planets P1 of the first set and the revolving planets P2 of the second set also have the same number of teeth. The input of the drive power into the differential gear is realized via the ring gear 7 and the epicyclic gear housing U. A symmetrical division of torque and a division of power to the output sun gears 1, 2 is realized via the revolving planets P1, P2. Flange sections 1b, 2b are constructed on the output sun gears 1, 2. These flange sections 1b, 2b are configured with an inner toothing 1c, 2c. End segments of wheel drive shafts or other power transfer components of the respective wheel drivetrain can be inserted into this inner toothing 1c, 2c, said end segments accordingly having complementary toothing. In place of the inner toothing shown here, other connection geometries can also be possible for the transmission of rotational torque, and for centering and receiving corresponding components.

The ring gear 7 seated on the epicyclic gear housing U in a non-rotatable manner is driven via a primary drive sprocket 8. The ring gear 7 and the primary drive sprocket 8 form a right-angled drive. The embodiment shown here is therefore particularly suitable as an axle differential for a rear axle which can be selectively decoupled from the primary drivetrain. In place of the transmission of rotary torque via a right-angled drive indicated here, it is also possible for a spur gear to be configured on the epicyclic gear housing U, which is driven via a further spur gear, by way of example. Such a variant is then particularly suitable for direct installation in a vehicle transmission.

The planetary carrier 3 sits between the ring element R and the brake disk pack BLP. The axial force transmission between the ring element R and the brake disk pack BLP is realized in this case primarily via the planet pins 6 and the planetary carrier 3 itself, braced by the same.

The planetary carrier 3 is composed of two carrier jackets 3a, 3b and a carrier pin 3c. The carrier jackets 3a, 3b are each produced as molded sheet metal part. These two carrier jackets 3a, 3b and the carrier pins 3c are welded to each other. For this purpose, rods are formed on the first carrier jacket 3a, which as such bridge the tooth region. The first carrier jacket 3a forms an inner bore hole in which an extension of the first output sun gear 1 is accommodated in a manner allowing rotation. The brake disk pack BLP sits on the carrier pin 3c. When the brake disk pack BLP is fully braked, the planetary carrier 3 can therefore be coupled by a friction fit to the epicyclic gear housing U. The brake disk pack BLP and the actuating mechanism 5 which is configured to load the same axially are designed in such a manner that it is possible for the drive torque applied to the ring gear 7 to be transmitted to the planetary carrier 3 via the brake disk pack BLP when the same is loaded axially.

The mounting of the planetary carrier 3 in the epicyclic gear housing U is realized via a first needle roller bearing N1 and a second needle roller bearing N2. The mounting of the epicyclic gear housing U in the gear housing G is realized via the bearing devices L1, L2. The bearing device L2 directs the gear reaction force components, which engage the ring gear 7 and are oriented axially, into the gear housing G. Neither the bearing N1 nor the bearing N2 needs to convey axial forces. The primary purpose of these bearings N1, N2 is to center and mount the planetary carrier 3 in the epicyclic gear housing U.

The functionality of the differential gear according to the invention is as follows: The ring gear 7 is driven by the primary drive sprocket 8. The ring gear 7 is fixed to the epicyclic gear housing U in a manner preventing rotation. Accordingly, the epicyclic gear housing U is made to rotate via the ring gear 7. This epicyclic gear housing U is arranged concentrically with a gear axle X, and mounted in the gear housing G via the first and the second bearing devices L1, L2 in a manner allowing rotation, and in this case is positioned axially by the second bearing device L2, the same designed as a fixed bearing having two roller element crowns which bear axially.

The brake disk rings 4b of the brake disk pack BLP which are also coupled to the epicyclic gear housing U in a non-rotatable manner rotate together with the same. The brake disk pack BLP is loaded axially by the pressure ring 4d and the annular plate 4c according to the magnitude of the axial force generated by the actuating mechanism 5, and are thereby optionally brought into a coupled state in which the epicyclic gear housing U and the planetary carrier 3 are coupled by a friction fit. A division of power is realized inside the planetary carrier 3 via the planets P1, P2 and the output sun gears 1, 2.

The planetary gear train accommodated in this case in the epicyclic gear housing U forms a spur gear differential, as already described. In the embodiment shown here, the output sun gear 1, 2 and the planet gears P1, P2 of the planetary arrangement P are configured with a Wildhaber/Novikov toothing. The first output sun gear 1 in this case has a toothing with a small addendum circle and concave tooth flank surfaces. The second output sun gear 2 has a toothing with a large addendum circle and convex tooth flank surfaces. The addendum circle diameter of the first output sun gear 1, and theoretic root circle of the second output sun gear 2 approximately correspond to the same, identical semicircle diameter. Both gears 1, 2 have the same number of teeth. The first output sun gear 1 engages with the revolving planets P1. The second output sun gear 2 engages with the revolving planets P2. The revolving planets P1 have a large addendum circle diameter and form convex tooth flanks The revolving planets P2 have a small addendum circle diameter and form concave tooth flanks The revolving planets P1, P2 engage with each other in pairs. The engagement occurs in the engagement plane of the first revolving planets P1 with the first output sun gear 1. The first revolving planets P1 have an axial length which corresponds substantially to the axial length of the toothing 1a of the first output sun gear 1. The second revolving planets P2 have an axial length which corresponds substantially to the sum of the axial lengths of the toothings 1a, 2a of the two output sun gears 1, 2.

The planet pins 6 are supported axially on the pressure ring element R. This pressure ring element R is in turn supported by the plunger elements Q1 which are guided in the base wall U2a of the bowl housing in a manner allowing axial sliding. The plunger elements Q1 are supported axially on the race R1 of the first axial bearing AX1. The rollers L1r of this first axial bearing AX1 roll directly on a circular end face F1 of the outer bearing ring of the cylindrical roller bearing L1, which as such only bears the epicyclic gear housing U radially in the gear housing G.

The outer bearing ring L1a, the axial bearing AX1, the planet pins 6, and the brake disk pack BLP are matched to each other and designed in such a manner that there is a substantially straight-line transmission of axial force through the planetary carrier, and the transfer of force into the gear housing G occur at the radial distance of the brake disk pack BLP.

What is claimed is:

1. A differential gear, having:
a gear housing (G);
an epicyclic gear housing (U) which is arranged in the gear housing (G) in a manner allowing rotation about a gear axis (X);
a drive wheel (7) which sits on the epicyclic gear housing (U) for the purpose of driving the epicyclic gear housing (U);
a first bearing device (L1) for the purpose of mounting a first axial end region of the epicyclic gear housing (U) radially;
a second bearing device (L2) for the purpose of mounting a second axial end region of the epicyclic gear housing (U) radially;
wherein the second bearing device (L1) has a first and a second rolling element crown (KW2, KW3) which are arranged in such a manner that they bear axially in opposite directions;
and, the axial position of the epicyclic gear housing (U) with respect to the gear housing (G) is determined by the second bearing device (L2).

2. The differential gear recited in claim 1, wherein the differential gear has a planetary carrier (3) arranged coaxially with the gear axle (X) in the epicyclic gear housing (U), and a brake device (BLP) for the purpose of generating a coupling torque which couples the planetary carrier (3) to the epicyclic gear housing (U).

3. The differential gear recited in claim 1, wherein the second bearing device has a ring element (W2) which forms a first end face (W2br) which bears axially, and a second end face (W2cr) which bears axially.

4. The differential gear recited in claim 3, wherein the ring element has a flange section (W2a), and this flange section forms a cylindrical running surface (W2ar) which bears radially.

5. The differential gear recited in claim 4, wherein the cylindrical running surface (W2a) of the ring element (W2) is supported radially by a needle roller bearing crown (KW1).

6. The differential gear recited in claim 3, wherein the end faces (W2br, W2cr) of the ring element (W2) which bear axially are each supported axially by a cylindrical roller bearing crown (KW2, KW3).

7. The differential gear recited in claim 1, wherein the ring element (W2) is manufactured as a molded sheet metal part and has an angular cross-section in the axial segment.

8. The differential gear recited in claim 1, wherein the ring element (W2) is seated on a cylindrical flange (B2) of the epicyclic gear housing (U), and is fixed thereon axially.

9. The differential gear recited in claim 1, wherein the first bearing device (L1) is designed as a cylindrical roller bearing or a needle roller bearing.

10. The differential gear recited in claim 1, wherein the axial position of the epicyclic gear housing (U) in the gear housing (G) is determined by the second bearing device (L2), and in that this second bearing device (L2) is pre-tensioned axially.
